(19) United States
(12) Patent Application Publication
(10) Pub. No.: US 2006/0294370 A1
(43) Pub. Date: Dec. 28, 2006

(54) Method, device, and system of maintaining a context of a secure execution environment

(76) Inventor: Ronen Greenspan, Tel-Aviv (IL)

Correspondence Address: PEARL COHEN ZEDEK, LLP;PEARL COHEN ZEDEK LATZER, LLP, 1500 BROADWAY 12TH FLOOR, NEW YORK, NY, 10036, US

(21) Appl. No.: 11/448,920

(22) Filed: Jun. 8, 2006

Related U.S. Application Data
(60) Provisional application No. 60/688,367, filed on Jun. 8, 2005.

(51) Int. Cl. H04L 9/00

(52) U.S. Cl. 713/164

(57) ABSTRACT

Some demonstrative embodiments of the invention include a method, device and/or system of maintaining a context of a secure execution environment. According to some demonstrative embodiments of the invention, the device may include a secure context processing module to receive a processed context from a first process operating in the secure execution environment; encrypt the processed context using a secret key maintained in the secure execution environment to generate an encrypted context; and provide the encrypted context to a second process operating in a non-secure execution environment. Other embodiments are described and claimed.

### CROSS REFERENCE TO RELATED APPLICATIONS

This application claims priority of U.S. Provisional Application No. 60/698,367, filed Jun. 8, 2005, the entire disclosure of which is incorporated herein by reference.

### BACKGROUND OF THE INVENTION

Cryptographic operations may be non-atomic, in the sense that they require more than one function call to process data, e.g., when the data to be processed is not fully available, and/or needs to be processed piecemeal, e.g., as it arrives. Intermediate data resulting from the process may be stored in memory, e.g., between function calls. The intermediate data may usually contain sensitive information, such as a cryptographic key, that may be valuable to a potential attacker. Therefore, there may be a need to protect and/or secure the intermediate data.

Conventional operating systems may include a partition between an un-trusted operating mode, e.g., a “user mode”, and a trusted operating mode, e.g., a “kernel mode”. The conventional systems may store the intermediate data in kernel memory. However, the kernel memory may be a scarce resource, which may be hard to manage dynamically. Thus, a relatively small amount of intermediate data may be stored in the kernel memory. This may limit the number of cryptographic operations, which may be preformed by the operating system, e.g., simultaneously. In addition, allocating a part of the kernel memory for storing the intermediate data may result in the allocated memory being unavailable for other uses, even when no cryptographic operations are in process.

### SUMMARY OF SOME DEMONSTRATIVE EMBODIMENTS OF THE INVENTION

Some demonstrative embodiments of the invention include a method, device and/or system of maintaining a context of a secure execution environment.

According to some demonstrative embodiments of the invention, the device may include a secure context processing module to receive a processed context from a first process operating in the secure execution environment; encrypt the processed context using a secret key maintained in the secure execution environment to generate an encrypted context; and provide the encrypted context to a second process operating in a non-secure execution environment.

According to some demonstrative embodiments of the invention, the context processing module may decrypt a received context using the secret key to generate a decrypted context. The received context may be received, for example, from a third process operating in the non-secure execution environment. The context processing module may also provide the decrypted context to a fourth process operating in the secure execution environment. The received context may include, for example, the encrypted context. In one example, the third process may include the second process. In another example, the third process may be different than the second process. In one example, the fourth process may include the first process. In another example, the fourth process may be different than the first process.

According to some demonstrative embodiments of the invention, the context processing module may generate authentication information corresponding to the processed context, and may authenticate a context received from the non-secure execution environment based on the authentication information.

According to some demonstrative embodiments of the invention, the context processing module may generate integrity information corresponding to the processed context, and may verify the integrity of a context received from the non-secure execution environment based on the integrity information.

According to some demonstrative embodiments of the invention, the context processing module may generate session information identifying a session during which the encrypted context is generated, and may verify the session of a context received from the non-secure execution environment based on the session information.

According to some demonstrative embodiments of the invention, the context processing module may store the encrypted context in a memory address associated with the non-secure execution environment.

According to some demonstrative embodiments of the invention, the first process may include at least part of a cryptographic process.

According to some demonstrative embodiments of the invention, the context processing module may operate in the secure execution environment.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a computing system including a Context Processing Module (CPM) in accordance with one demonstrative embodiment of the invention;

FIG. 2 is a schematic illustration of a computing system including a CPM in accordance with another demonstrative embodiment of the invention;

FIG. 3 is a conceptual illustration of a CPM operating in association with a Secure Execution Environment (SEE) and a Non-Secure Execution Environment (NSEE) in accordance with some demonstrative embodiments of the invention;

FIG. 4 is a schematic flowchart of a method of encrypting and/or decrypting a context in accordance with some demonstrative embodiments of the invention;

FIG. 5 is a schematic flowchart of a method of generating an encrypted context in accordance with some demonstrative embodiments of the invention; and

FIG. 6 is a schematic flowchart of a method of performing one or more operations using an encrypted context in accordance with some demonstrative embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art. An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

Embodiments of the present invention may include apparatuses for performing the operations herein. These apparatuses may be specially constructed for the desired purposes, or they may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, a Dynamic RAM (DRAM), a Synchronous DRAM (SD-RAM), a Flash memory, a volatile memory, a non-volatile memory, a cache memory, a buffer, a short term memory unit, a long term memory unit, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. Although the invention is not limited in this respect, some demonstrative embodiments of the invention may be implemented using any suitable embedded system.

Part of the discussion herein may relate, for demonstrative purposes, to performing one or more operations on a context. The term “context” as used herein may refer to data, a data block, a data portion, a data sequence, a data frame, a data field, a data record, a data stream, a data string, a data file, code, a code block, a code portion, a code sequence, a code field, a code stream, a content, an item, a message, a key, or the like. The context may include, for example, data resulting from one or more operations, e.g., cryptographic operations, performed in a secure execution environment.

The phrase “secure execution environment” (SEE) as used herein may refer to an environment, mode of operation, and/or operating condition, to prevent unauthorized, uncertified and/or unapproved access, e.g., partial or complete physical and/or electronic access, to one or more processes, instructions and/or operations executed, and/or performed in the SEE; and/or to data, code, and/or any other information managed, stored, and/or maintained in the SEE. The SEE may be implemented using any suitable arrangement, configuration, and/or combination of hardware and/or software. For example the SEE may be implemented by an operating system and/or secure hardware, alone or in combination. Accordingly, a Non-Secure Execution Environment (NSEE) may refer to any environment, mode of operation, and/or operating condition, different than the SEE, e.g., wherein unauthorized, uncertified and/or unapproved access is not prevented. The NSEE and SEE may be implemented using separate and/or common arrangements, configurations, and/or combinations of resources, hardware and/or software. In one example, the SEE and NSEE may be implemented using a common processor having a secure mode of operation and a non-secure mode of operation. For example, the SEE may be implemented as part of a kernel mode of operation, e.g., as is known in the art; and the NSEE may be implemented as part of a User mode of operation, e.g., as is known in the art. In another example, the SEE may be implemented by a protected processor, and the NSEE may be implemented by another, e.g., non-protected, processor. In yet another example, the SEE may be implemented as a dedicated mode, e.g., a trusted mode, a safe mode, a secure mode, or any other suitable mode, as are known in the art.

Some demonstrative embodiments of the invention may include a method, device and/or system to perform one or more operations on a context. For example, the method, device and/or system may generate, maintain, and/or transfer one or more contexts between a SEE and a NSEE. The context may include, for example, a context received from the SEE, e.g., from a first process operating in the SEE. The context may be encrypted using a secret key, which may be maintained in the SEE, to generate an encrypted context, which may be provided, for example, to the NSEE, e.g., to a second process operating in the NSEE, as described in detail below.

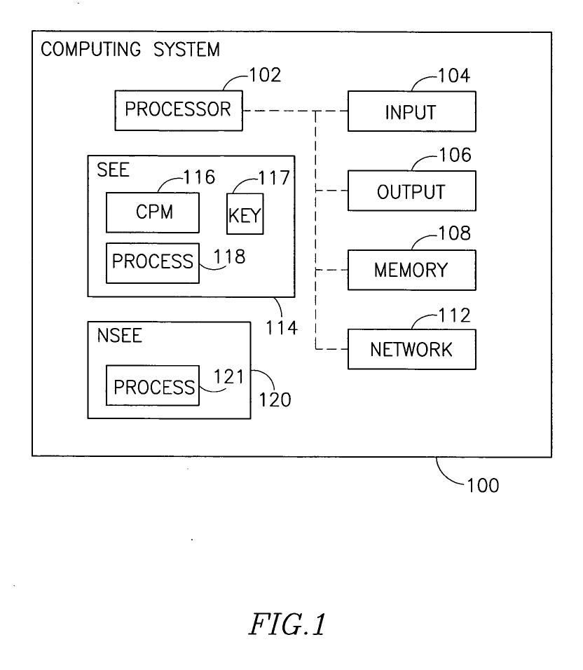

Reference is made to FIG. 1, which schematically illustrates a computing system 100 according to one demonstrative embodiment of the invention.

According to some demonstrative embodiments of the invention, system 100 may include a processor 102, an input unit 104, an output unit 106, a memory 108, and/or a network connection 112. Processor 102 may include, for example, a Central Processing Unit (CPU), a Digital Signal Processor (DSP), a microprocessor, a host processor, a plurality of processors, a controller, a microcontroller, a chip, a microchip, or any other suitable multi-purpose or specific processor or controller. Input unit 104 may include, for example, a keyboard, a mouse, a touch-pad, a communication port, e.g., a Universal Serial Bus (USB), or other suitable pointing device or input device. Output unit 106 may include, for example, a Cathode Ray Tube (CRT) monitor, a Liquid Crystal Display (LCD) monitor, or other suitable monitor or display unit. Memory 108 may include, for example, a RAM, a ROM, a DRAM, a SD-RAM, a Flash memory, a volatile memory, a non-volatile memory, a cache memory, a buffer, a short term memory unit, a long term memory unit, or other suitable memory units or storage units. Network connection 112 may be adapted to interact with a communication network, for example, a local area network (LAN), wide area network (WAN), or a global communication network, for example, the Internet. According to some embodiments the communication network may include a wireless communication network such as, for example, a wireless LAN (WLAN) communication network. Although the scope of the present invention is not limited in this respect, the communication network may include a cellular communication network, with host 104 being, for example, a base station, a mobile station, or a cellular handset The cellular communication network, according to some embodiments of the invention, may be a 3^{rd} Generation Partnership Project (3GPP), such as, for example, Frequency Domain Duplexing (FDD), Global System for Mobile communications (GSM), Wideband Code Division Multiple Access (WCDMA) cellular communication network and the like.

According to some demonstrative embodiments of the invention, system 100 may also include a SEE 114 and a NSEE 120. SEE 114 and/or NSEE 120 may be implemented using any suitable arrangement, configuration, and/or combination of hardware and/or software. SEE 114 and/or NSEE 120 may be implemented, for example, by processor 102, memory 108, and/or any suitable hardware and/or software modules, e.g., as are known in the art. In one example, SEE 114 and NSEE 120 may be implemented using a common processor, e.g., processor 102, having a secure mode of operation and a non-secure mode of operation. For example, SEE 114 may be implemented as part of a kernel mode of operation of an Operating System (OS) executed by processor 102, and NSEE 120 may be implemented as part of a user mode of operation of the OS. In another example, NSEE 120 may be implemented by processor 102 and/or memory 108; and SEE 114 may be implemented by a protected processor and/or memory (not shown), e.g., different than processor 102 and/or memory 108. In yet another example, SEE 114 may be implemented by a dedicated mode, e.g., a trusted mode, safe mode, and the like.

According to some demonstrative embodiments of the invention, system 100 may also include a secure Context Processing Module (CPM) 116 to receive a context from SEE 144, e.g., from a secure process 118 operating in SEE 114; encrypt the context using a secret key 117, which may be securely maintained, e.g., in SEE 114; and/or provide the encrypted context to a non-secure process 121 operating in NSEE 120, e.g., as described in detail below. CPM 116 may be implemented by any suitable hardware, and/or software, or any combination thereof.

According to some demonstrative embodiments of the invention, process 118 may include any suitable process or application performed in SEE 114. For example, process 118 may include a cryptographic process or application, e.g., an encryption process, a decryption process, a signature verification/authentication process, any suitable security protocol, e.g., a secure communication protocol, and the like. Process 121 may include any suitable process or application which may interact with SEE 114, e.g., with process 118. For example, process 121 may provide SEE 114 with an input to be securely processed, e.g., by process 118. The input may include, for example, data to be encrypted, decrypted, verified and/or authenticated.

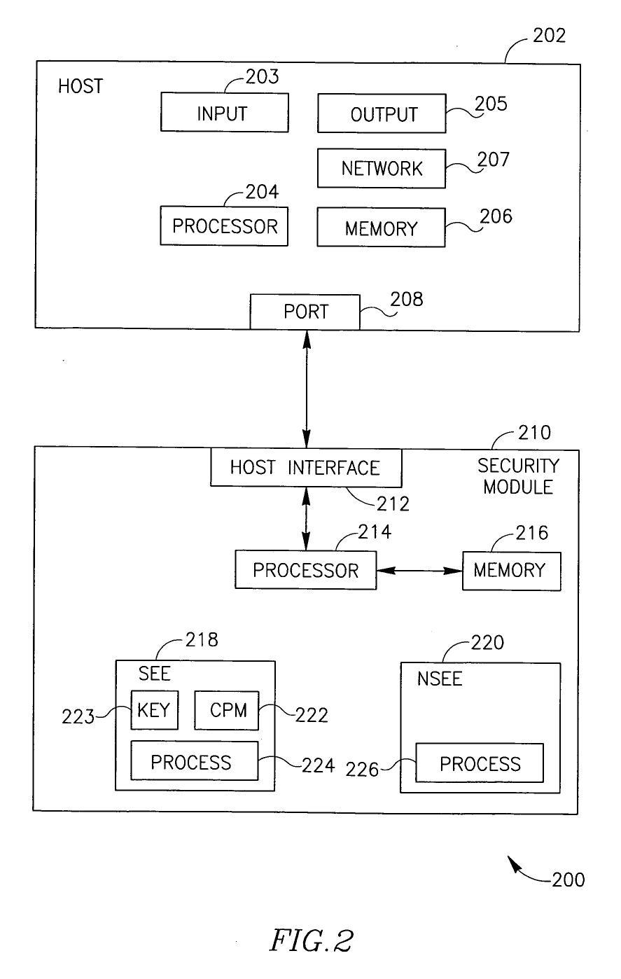

Reference is now made to FIG. 2, which schematically illustrates a computing system 200 according to another demonstrative embodiment of the invention. System 200 may include a host 202 associated with a security module 210, as are described in detail below.

Although the present invention is not limited in this respect, host 202 may be a portable device. Non-limiting examples of such portable devices include mobile telephones, laptop and notebook computers, personal digital assistants (PDA), and the like. Alternatively, host 202 may be a non-portable device, such as, for example, a desktop computer.

Although the invention is not limited in this respect, secure module 210 may be a portable device, e.g., a portable memory card, a flashcard, a disk, a chip, a token, a smartcard, and/or any other portable device, which may be, for example, detachable from host 202. For example, host 202 may include, or may be, a mobile telephone or a cellular handset; and secure module 210 may include or may be, for example, a memory card detachable from the mobile telephone or handset. According to other embodiments, secure module 210 may be a non-portable device, for example, a memory card, e.g., a flashcard, a disk, chip, a token, a smartcard, and/or any other storage unit or element integrally connected to, or included within, host 202. For example, host 202 may include, or may be, a mobile telephone or a cellular handset; and secure module 210 may include or may be, for example, a memory embedded in the mobile telephone or handset.

According to some demonstrative embodiments of the invention, host 202 may include a processor 204 associated with a memory 206. Host may optionally include an input 203, an output 205, and/or a network connection 207, which may include an input, an output, and/or a network connection analogous to input 104, output 106 and/or network 112, respectively, as described above with reference to FIG. 1. Host 202 may also include a port 208 associated with a host interface 212 of security module 210. Port 208 and interface 212 may include any suitable port and interface, e.g., as are known in the art, to enable communication between host 202 and secure module 210.

According to some demonstrative embodiments of the invention, secure module 210 may include a processor 214 associated with a memory 216. Processors 204 and/or 214 may include, for example, a CPU, a DSP, a microprocessor, a host processor, a plurality of processors, a controller, a chip, a microchip, or any other suitable multi-purpose or specific processor or controller. Memory 206 and/or memory 216 may include, for example, a RAM, a ROM, a DRAM, a SD-RAM, a Flash memory, a volatile memory, a non-volatile memory, a cache memory, a buffer, a short term memory unit, a long term memory unit, or other suitable memory units or storage units.

According to some demonstrative embodiments of the invention, secure module 210 may also include a SEE 218 and a NSEE 220. SEE 114 and/or NSEE 120 may be implemented using any suitable arrangement, configuration, and/or combination of hardware and/or software, e.g., in analogy to SEE 114 and/or NSEE 120 as described above with reference to FIG. 1. Although some demonstrative embodiments of the invention relate to a NSEE, e.g., NSEE 220, and a SEE, e.g., SEE 218, implemented within a single module, e.g., module 210, it will be appreciated by those of ordinary skill in the art that in other embodiments of the invention, the SEE and NSEE may be implemented in any other suitable configuration. For example, the NSEE may be implemented by a host, e.g., host 202, and the SEE may be implemented by a module associated with the host, e.g., module 210.

According to some demonstrative embodiments of the invention, secure module 210 may also include a secure CPM 222 to receive a context from SEE 218, e.g., from a process 224 operating in SEE 218; encrypt the context using a secret key 223, which may be securely maintained, e.g., in SEE 218; and/or provide the encrypted context to NSEE 220, e.g., to a process 226 operating in NSEE 220, e.g., as described in detail below. Although the invention is not limited in this respect, CPM 222 may operate, for example, in SEE 218.

According to some demonstrative embodiments of the invention, process 224 may include any suitable process or application performed in SEE 218. For example, process 224 may include a cryptographic process, e.g., an encryption process, a decryption process, a signature verification/authentication process, and the like. Process 226 may include any suitable process or application which may interact with SEE 218, e.g., with process 224. For example, processor 204 may transfer an instruction or command to processor 214, e.g., via port 208 and interface 212. Processor 214 may retrieve from memory 216 and, execute instructions resulting in process 226, e.g., based on the received instruction or command. Process 226 may provide SEE 218 with an input to be securely processed, e.g., by process 224. The input may include, for example, data to be encrypted, decrypted, verified and/or authenticated, and the like.

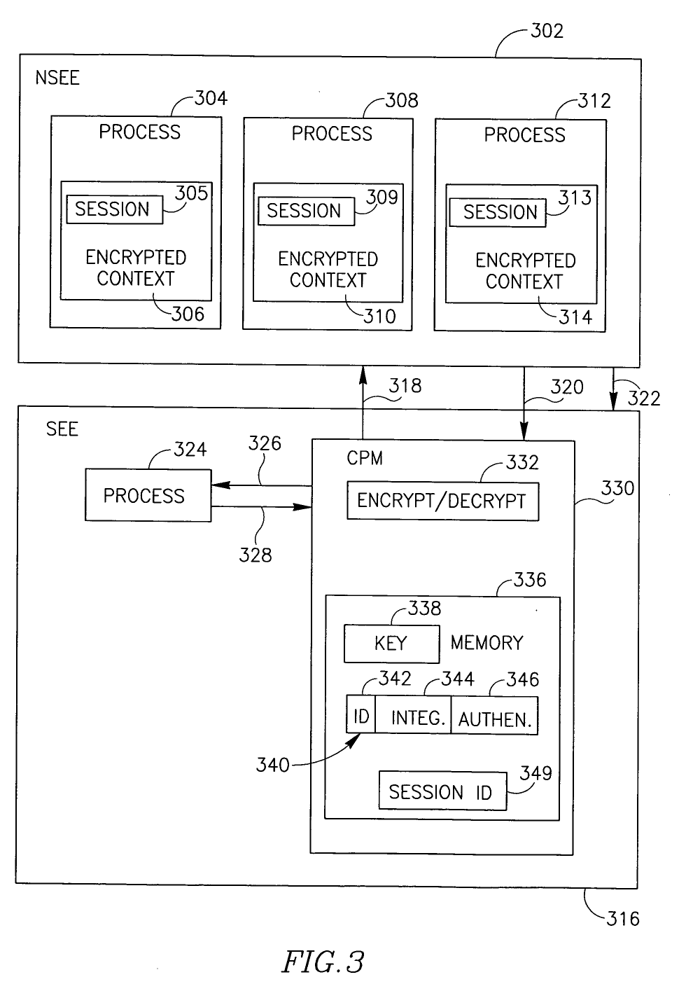

Reference is now made to FIG. 3, which conceptually illustrates a CPM 330 in association with a SEE 316 and a NSEE 302 in accordance with some demonstrative embodiments of the invention. Although the invention is not limited in this respect, CPM 330 may perform the functionality of CPM 116 (FIG. 1), and/or CPM 222 (FIG. 2); SEE 316 may perform the functionality of SEE 114 (FIG. 1), and/or SEE 218 (FIG. 2); and/or NSEE 302 may perform the functionality of NSEE 120 (FIG. 1), and/or NSEE 220 (FIG. 2).

According to some demonstrative embodiments of the invention, one or more non-secure processes, e.g., processes 304, 308 and/or 312, may operate in NSEE 302. Processes 304, 308, and/or 312 may include any suitable processes operating in a NSEE, e.g., as are known in the art. Although the invention is not limited in this respect, processes 304, 308, and/or 312 may include or may be process 121 (FIG. 1) and/or process 226 (FIG. 2).

According to some demonstrative embodiments of the invention, at least one secure process, e.g., process 324, may operate in SEE 302. Process 324 may include any suitable process operating in a SEE, e.g., a cryptographic process as is known in the art. Although the invention is not limited in this respect, process 324 may include or may be process 118 (FIG. 1) and/or process 224 (FIG. 2).

According to some demonstrative embodiments of the invention, CPM 330 may operate in SEE 316. CPM 330 may receive at least one context 328 from SEE 316, e.g., from process 324. Context 328 may include, for example, processed or partially processed data. For example, process 324 may perform a series of operations on an input, which may be received, for example, from one or more of processes 304, 308, and/or 312. The series of operations may include, for example, a plurality cryptographic operations, e.g., a plurality of non-atomic operations; and the processed context may include, for example, a result of one or more of the operations. It will be appreciated by those of ordinary skill in the art that in other demonstrative embodiments of the invention, context 328 may include any other suitable information and/or data. For example, process 324 may generate context 328 corresponding to one or more instructions and/or commands, e.g., initialization instructions to perform one or more operations, which may be received from processes 304, 308 and/or 312.

According to some demonstrative embodiments of the invention, CPM 330 may encrypt context 328 using a secret key 338 to generate an encrypted context 318. CPM 330 may provide encrypted context 318, for example, to process 304, process 308 and/or process 312.

Although the invention is not limited in this respect, according to some demonstrative embodiments of the invention, CPM 330 may provide a plurality of encrypted contexts, e.g., corresponding to one or more contexts received from processor 324, to one or more of the non-secure processes operating in NSEE 302, e.g., as described below. For example, CPM 330 may provide process 304 with an encrypted context 306, e.g., corresponding to a first context received from process 324; provide process 304 with an encrypted context 310, e.g., corresponding to a second context received from process 324; and/or provide process 312 with an encrypted context 314, e.g., corresponding to a third context received from process 324. The first, second, and third contexts received from processor 324 may include the same context, or two or more different contexts.

According to some demonstrative embodiments of the invention, CPM 330 may receive from NSEE 302 an encrypted context 320 to be provided to a secure process in SEE 316, e.g., process 324. Context 320 may include or may be, for example, context 306, 310 or 312. CPM 330 may decrypt encrypted context 320, e.g., using key 338, to generate a decrypted context 326, which may be provided, for example, to process 324. Although some demonstrative embodiments of the invention are described with reference to receiving the encrypted context from the NSEE, it will be appreciated that in other embodiments the encrypted context may be provided within the SEE. For example, context 320 may be provided to CPM 330 by a process or application within SEE 316. NSEE 302 may provide, for example, an encrypted context to process 324, and process 324 may provide the encrypted context to CPM 330, e.g., via a shared memory (not shown).

According to some demonstrative embodiments of the invention, CPM 330 may include an encryptor/decryptor 332 to encrypt context 328, and/or decrypt context 320. Encryptor/decryptor 334 may include, for example, a symmetric encryption/decryption engine, e.g., as is known in the art. The encryption decryption engine may implement, for example, an Advanced Encryption Standard (AES) block cipher, e.g., a CBC block cipher mode, or any other suitable encryption/decryption algorithm as is known in the art. Encryptor/decryptor 334 may include any other encryptor/decryptor, e.g., as is known in the art. CPM 330 may also include a memory 336. Memory 336 may include any suitable memory, e.g., a RAM, a DRAM, an SD-RAM, a Flash memory, or any other suitable non-volatile, memory or storage. Although the invention is not limited in this respect, memory 336 may store key 338. Alternatively, key 338 may be securely stored by any other suitable element of CPM and/or any suitable secure element operating in SEE 316, e.g., an EEPROM memory or a one-time programmable fuse, as are known in the art.

Although the invention is not limited in this respect, according to some demonstrative embodiments of the invention, CPM 330 may generate integrity information 344 corresponding context 328. Integrity information 344 may include any suitable integrity information, e.g., as is known in the art. For example, integrity information 344 may include a hash value, which may be derived, for example, from context 320 or encrypted context 318, e.g., using any suitable hash algorithm. For example, CPM 330 may generate integrity information 344 using a Hash function, as is known in the art. Integrity information 344 may be included as part of encrypted context 318 or may be maintained by CPM 330, e.g., as described below.

According to some demonstrative embodiments of the invention, CPM 330 may generate authentication information 346 corresponding context 328. Authentication information 346 may include any suitable authentication information, e.g., an authentication key. For example, authentication information 346 may include a Message Authentication Code (MAC), which may be calculated, for example, from key 338(Which is not recommended) or from a derivation of key 338 and context 328 or encrypted context 318, e.g., using a hash algorithm, a block cipher algorithm, such as, for example, a CBC-MAC algorithm, and/or any other suitable method as known in the art. Authentication information 346 may include any other suitable integrity information, e.g., a secure checksum value, as is known in the art. For example, CPM 330 may generate authentication information 346 using a keyed-Hash algorithm, e.g., an H-MAC algorithm as is known in the art. Authentication information 346 may be included as part of encrypted context 318, may be associated with encrypted context 318, or may be maintained by CPM 330, e.g., as described below.

Although the invention is not limited in this respect, according to some demonstrative embodiments of the invention, memory 336 may store a plurality of integrity information and/or a plurality of authentication information, e.g., corresponding to a plurality of encrypted contexts. Although the invention is not limited in this respect, integrity information 344 and/or authentication information 346 may be stored, for example, in the form of at least one table including at least one IDs 340 to identify at least one encrypted context, and integrity information 344 and/or authentication information 346 corresponding to the encrypted context identified by context ID 340. Any suitable ID and/or user authentication information, e.g., one or more digital certificates and/or shared keys, may be implemented additionally or alternatively for identifying and/or authenticating a user.

According to some demonstrative embodiments of the invention, a session may be established between one or more processes operating in NSEE 302, e.g., processes 304, 308, and/or 312, and CPM 330. During the session, CPM 330 may generate one or more encrypted contexts, e.g., corresponding to one or more contexts generated in SEE 316; and/or decrypt one or more encrypted contexts received from NSEE 302. The session may begin, for example, when CPM 330 receives instructions 322 causing CPM 330 to generate the one or more encrypted contexts. The session may be terminated, for example, by providing to CPM 330 instructions 322 including an End-Of-Session (EOS) command. Although the invention is not limited in this respect, CPM 330 may associate encrypted context 318 with the session during which encrypted context 318 is generated, e.g., in order to protect encrypted context 318 against a session-replay attack. For example, CPM 330 may associate encrypted context 306 with a session indicator 305 indicating a session during which context 306 has been generated; associate encrypted context 310 with a session indicator 309 indicating a session during which context 310 has been generated; and/or associate encrypted context 314 with a session indicator 313 indicating a session during which context 314 has been generated. Although the invention is not limited in this respect, session indictors 305, 309, and/or 313 may include, for example, a pseudo-random number, which may be attached to, or included within, encrypted contexts 306, 310, and/or 314, respectively. For example, the session indicator may include a 32-bit pseudo-random number, e.g., generated by a Pseudo-Random-Number-Generator (PRNG), as is known in the art. CPM 330 may also maintain, for example, one or more valid session identifiers 349, e.g., in the form of a list, corresponding to one or more of session indicators 305, 309 and 313.

According to some demonstrative embodiments of the invention, CPM 330 may selectively decrypt encrypted context 320, based on the session indicator associated with encrypted context 320, e.g., as described below. For example, CPM 330 may enable decryption of encrypted context 320, e.g., if the session indicator of context 320 matches one or more session identifiers 349; and/or block encrypted context 320, e.g., if the session indicator of context 320 does not match any one of one or more session identifiers 349.

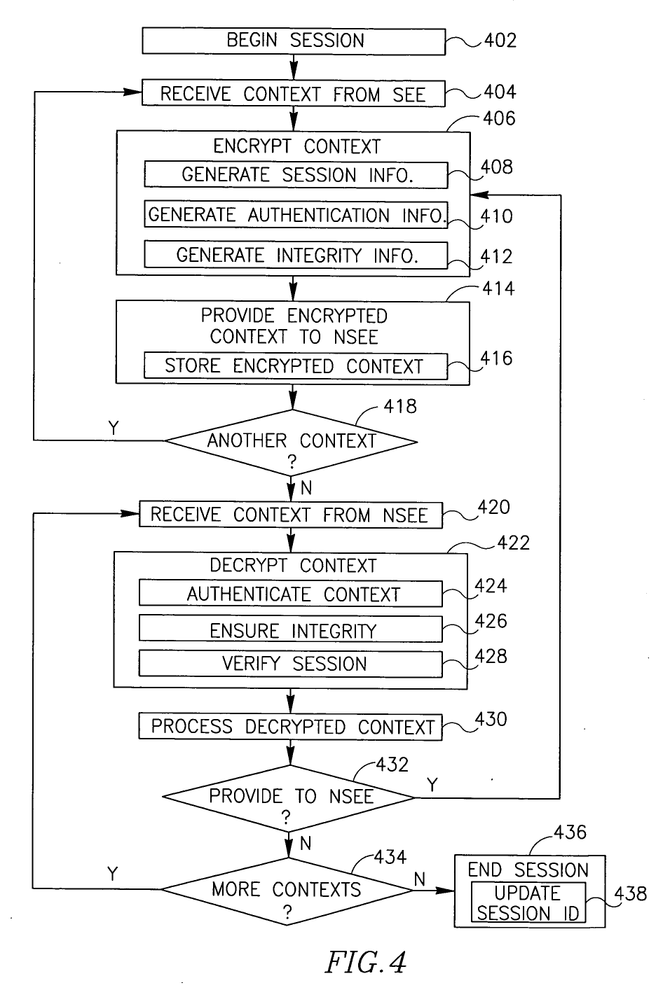

Reference is now made to FIG. 4, which schematically illustrates a method of encrypting and/or decrypting a context in accordance with some demonstrative embodiments of the invention. Although the invention is not limited in this respect, one or more operations of the method of FIG. 4 may be performed by CPM 330 (FIG. 3), and/or process 324 (FIG. 3), to encrypt and/or decrypt a context, e.g., within SEE 316 (FIG. 3).

As indicated at block 402, the method may include, beginning a session (“the current session”) during which one or more contexts are to be encrypted and/or decrypted in a SEE. For example, a session between CPM 330 (FIG. 3) and one or more processes in NSEE 302 (FIG. 3), e.g., processes 304, 308 and/or 312, may be initiated by instructions 322 (FIG. 3), which may include, for example, instructions and/or commands to generate one or more encrypted contexts.

As indicated at block 404, the method may include receiving a context from the SEE. For example, CPM 330 (FIG. 3) may receive a context, e.g., context 328 (FIG. 3), from a process, e.g., process 324 (FIG. 3), operating in SEE 316 (FIG. 3).

As indicated at block 406, the method may also include encrypting the context. For example, CPM 330 (FIG. 3) may encrypt context 328 (FIG. 3), e.g., as described above.

As indicated at block 408, encrypting the context may include, for example, generating session information corresponding to the current session. For example, CPM 330 (FIG. 3) may generate session indicator 305 (FIG. 3) when generating encrypted context 306 (FIG. 3). CPM 330 (FIG. 3) may also update session ID 349 (FIG. 3) to correspond to session indicator 305 (FIG. 3). For example, CPM 330 (FIG. 3) may update session ID 349 (FIG. 3) to include the value of session indicator 305 (FIG. 3).

As indicated at block 410, encrypting the context may include, for example, generating authentication information corresponding to the encrypted context. For example, CPM 330 (FIG. 3) may generate authentication information, e.g., as described above.

As indicated at block 412, encrypting the context may include, for example, generating integrity information corresponding to the encrypted context. For example, CPM 330 (FIG. 3) may generate integrity information, e.g., as described above.

As indicated at block 414, the method may also include providing the encrypted context to the NSEE. For example, CPM 330 (FIG. 3) may provide encrypted context 318 (FIG. 3) to one or more processes operating in NSEE 302 (FIG. 3), e.g., as described above. As indicated at block 416, providing the encrypted process may include, for example, storing the encrypted context. For example, CPM 330 (FIG. 3) may store encrypted context 318 (FIG. 3) in a memory operating in NSEE 302 (FIG. 3).

As indicated at block 418, the method may include repeating one or more operations of blocks 404, 406, and/or 414, e.g., to encrypt one or more other contexts, e.g., received from the SEE. For example, CPM 330 (FIG. 3) may encrypt one or more other contexts in SEE 316 (FIG. 3), and/or provide the one or more encrypted contexts to one or more processes operating in NSEE 302 (FIG. 3), e.g., during the current session.

As indicated at block 420, the method may include receiving an encrypted context from the NSEE. For example, CPM 330 (FIG. 3) may receive encrypted context 320 (FIG. 3) from NSEE 302 (FIG. 3), e.g., as described above. In one example, the received context of block 420 may include the context encrypted in the SEE during the current session, in accordance with blocks 404, 406, and/or 414. In another example, the received context of block 420 may include another context, e.g., decrypted during a previous session.

As indicated at block 422, the method may include decrypting the received encrypted context. For example, CPM 330 (FIG. 3) may decrypt context 320 (FIG. 3) to generate decrypted context 326 (FIG. 3) in SEE 316 (FIG. 3), e.g., as described above.

As indicated at block 424, the method may also include authenticating the encrypted context. For example, CPM 330 (FIG. 3) may authenticate encrypted context 320 (FIG. 3), e.g., as described above. For example, CPM 330 (FIG. 3) may calculate authentication information corresponding to context 320 (FIG. 3), and determine the authenticity of context 320 (FIG. 3) based on a comparison between the calculated authentication information and authentication information 346 (FIG. 3), e.g., as described above. CPM 330 (FIG. 3) may enable the decryption of encrypted context 320 (FIG. 3), e.g., if the calculated authentication information of context 320 (FIG. 3) matches authentication information 346 (FIG. 3); or block encrypted context 320 (FIG. 3), e.g., if the calculated authentication information of context 320 (FIG. 3) does not match authentication information 346 (FIG. 3).

As indicated at block 426, the method may also include ensuring the integrity of the encrypted context. For example, CPM 330 (FIG. 3) may verify the integrity of encrypted context 320 (FIG. 3) using integrity information 344 (FIG. 3), e.g., as described above. For example, CPM 330 (FIG. 3) may calculate integrity information corresponding to context 320 (FIG. 3), and verify the integrity of context 320 (FIG. 3) based on a comparison between the calculated integrity information and integrity information 344 (FIG. 3), e.g., as described above. CPM 330 (FIG. 3) may enable the decryption of encrypted context 320 (FIG. 3), e.g., if the calculated integrity information of context 320 (FIG. 3) matches integrity information 344 (FIG. 3); or block encrypted context 320, for example, from being processed by process 324 (FIG. 3), e.g., if the calculated integrity information of context 320 (FIG. 3) does not match integrity information 344 (FIG. 3).

As indicated at block 428, the method may include verifying the session of the encrypted context. For example, CPM 330 (FIG. 3) may compare the session indictor of context 320 (FIG. 3) to one or more session identifiers 349 (FIG. 3). CPM 330 (FIG. 3) may selectively decrypt encrypted context 320 (FIG. 3) and/or provide the decrypted context to process 324 (FIG. 3) based on the verification of the session indicator. For example, CPM 330 (FIG. 3) may enable the decryption of encrypted context 320, e.g., if the session indicator of context 320 (FIG. 3) matches one or more session identifiers 349 (FIG. 3); or block encrypted context 320 (FIG. 3), for example, from being processed by process 324 (FIG. 3), e.g., if the session indicator of context 320 (FIG. 3) does not match any one of one or more session identifiers 349 (FIG. 3).

Although the invention is not limited in this respect, in some demonstrative embodiments of the invention, CPM 330 (FIG. 3) may decrypt encrypted context 320 (FIG. 3) only if encrypted context 320 (FIG. 3) is authenticated, the integrity of encrypted context 320 (FIG. 3) is verified, and the session of encrypted context 320 (FIG. 3) is verified. In other demonstrative embodiments CPM 330 (FIG. 3) may perform one or more of authenticating encrypted context 320 (FIG. 3), verifying the integrity of context 320 (FIG. 3), and verifying the session of context 320 (FIG. 3).

As indicated at block 430, the method may also include processing the decrypted context in the SEE. For example, process 324 (FIG. 3) may process decrypted context 326 (FIG. 3) in SEE 316 (FIG. 3), e.g., as described above.

As indicated at block 432, the method may optionally include providing the processed context back to the NSEE. For example, the processed context may be encrypted and provided back to the NSEE, e.g., as indicated at blocks 406 and/or 414. For example, CPM 330 (FIG. 3) may receive the context processed by process 324 (FIG. 3), encrypt the context and provide the context back to NSEE.302 (FIG. 3).

As indicated at block 434, the method may include repeating one or more operations of blocks 420, 422, 430 and/or 432, e.g., to decrypt and/or process another context, e.g., received from the NSEE. For example, CPM 330 (FIG. 3) may decrypt one or more other contexts in SEE 302 (FIG. 3), and/or provide the one or more decrypted contexts to one or more processes operating in SEE 316 (FIG. 3), e.g., during the current session.

As indicated at block 436, the method may also include terminating the current session. For example, a process of NSEE 302 (FIG. 3), e.g., process 304, process 308 or process 312, may provide CPM 330 (FIG. 3) with the EOS command, using instructions 322 (FIG. 3). As indicated at block 438, the method may also include updating the one or more session identifiers, e.g., when terminating the current session, to indicate the session has terminated. For example, CPM 330 (FIG. 3) may delete session identifier 349 (FIG. 3) corresponding to the current session, e.g., when terminating the current session.

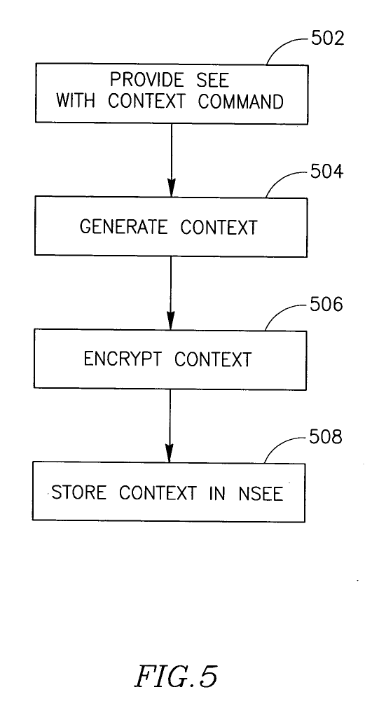

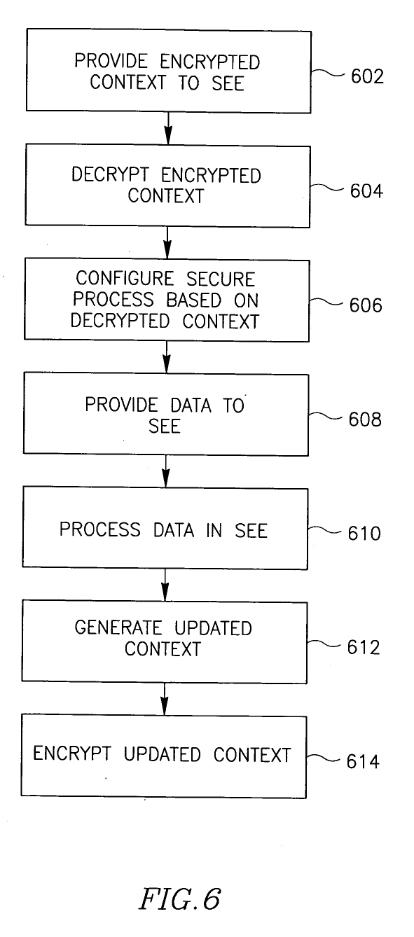

Referring back to FIG. 3, although the invention is not limited in this respect, according to one demonstrative embodiment of the invention, instructions 322 may include instructions to perform a series of operation, e.g., a series of non-atomic cryptographic operations, on data to be provided by NSEE 302, e.g., by processes 304, 308 and/or 312. For example, the cryptographic operations may include or may be part of, a signature authentication operation, or any other suitable cryptographic operation. CPM 330 may cause process 324 to provide CPM with context 328 corresponding to the cryptographic operation; encrypt context 328; and provide encrypted context 320 to the process in NSEE 302, e.g., as described in detail below with reference to FIG. 5. CPM 330 may receive the encrypted context together with data to be processed in SEE 316; decrypt the encrypted context; provide the context and data to process 324; receive an updated context from process 324; encrypt the updated context and provide the encrypted updated context back to the process in NSEE 302, e.g., as described in detail below with reference to FIG. 6.

Reference is now made to FIG. 5, which schematically illustrates a method of generating an encrypted context in accordance with some demonstrative embodiments of the invention. Although the invention is not limited in this respect, one or more operations of the method of FIG. 5 may be performed by CPM 330 (FIG. 3), process 324 (FIG. 3), and/or a non-secure process, e.g., process 304, 308 or 312 (FIG. 3), to generate an encrypted context, e.g., within SEE 316 (FIG. 3).

As indicated at block 502, the method may include providing the SEE with a command to generate an encrypted context. For example, process 304, 308, and/or 312 (FIG. 3) may provide CPM 30 (FIG. 3) with instructions 322 (FIG. 3) including one or more predefined parameters defining the context to be generated. The parameters may include, for example, a block cipher, e.g., AES; an operation mode, e.g., CBC; an operation, e.g., encryption; a key to be used, e.g., a self-generated key; and/or any other suitable parameter.

As indicated at block 504, the method may also include generating the context in the SEE, e.g., according to the predefined parameters. For example, CPM 330 (FIG. 3) may cause process 324 (FIG. 3) to generate context 328 (FIG. 3) according to the predefined parameters.

As indicated at block 506, the method may also include encrypting the context in the SEE. For example, CPM 330 (FIG. 3) may encrypt context 328 to generate encrypted context 320 (FIG. 3), e.g., as described above.

As indicated at block 508, the method may also include storing the encrypted context in the NSEE. For example, CPM 330 (FIG. 3) may store contest 320 (FIG. 3) in the non secure process, e.g., process 304, 308 or 312 (FIG. 3).

Reference is now made to FIG. 6, which schematically illustrates performing one or more operations on an encrypted context in accordance with some demonstrative embodiments of the invention. Although the invention is not limited in this respect, one or more operations of the method of FIG. 6 may be performed by CPM 330 (FIG. 3), process 324 (FIG. 3), and/or a non-secure process, e.g., process 304, 308 or 312 (FIG. 3), to perform one or more operations using an encrypted context, e.g., within SEE 316 (FIG. 3).

As indicated at block 602, the method may include providing the encrypted context to the SEE. For example, encrypted context 320 (FIG. 3) may be provided to CPM 330 (FIG. 3) by process 304, 308 or 312 (FIG. 3), e.g., via a shared memory.

As indicated at block 604, the method may also include decrypting the encrypted context in the SEE. For example, CPM 330 (FIG. 3) may decrypt encrypted context 320 (FIG. 3) to generate decrypted context 326 (FIG. 3), e.g., as described above.

As indicated at block 606, the method may also include configuring a secure process operating in the SEE based on the decrypted context. For example CPM 330 (FIG. 3) may initialize AES hardware with an IV, and/or initialize Hash hardware, based on decrypted context 329 (FIG. 3).

As indicated at block 608 the method may also include providing to the SEE data to be processed in the SEE. For example, process 304, 308 or 312 (FIG. 3) may provide SEE 316 (FIG. 3) with data to be processed securely by processor 324 (FIG. 3). The data may include, for example, data for performing one or more cryptographic operations, e.g., a signature to be authenticated, and the like.

As indicated at block 610, the method may include processing the data in the SEE. For example, process 324 (FIG. 3) may process the data, e.g., to perform one or more cryptographic operations on the data.

As indicated at block 612, the method may also include generating an updated context in the SEE, e.g., based on the processed data. For example, process 324 (FIG. 3) may generate an updated context including the processed data, and/or store intermediate values of the cryptographic operations.

As indicated at block 614, the method may include encrypting the updated context. For example, CPM 330 (FIG. 3) may receive the updated context from process 324 (FIG. 3), encrypt the updated context, and provide an encrypted updated context back to NSEE 302 (FIG. 3).

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. An apparatus having a secure execution environment and a non-secure execution environment, said apparatus comprising:
a secure context processing module to:
receive a processed context from a first process operating in said secure execution environment;
encrypt said processed context using a secret key maintained in said secure execution environment to generate an encrypted context; and
provide said encrypted context to a second process operating in said non-secure execution environment.

2. The apparatus of claim 1, wherein said context processing module decrypts a received context using said secret key to generate a decrypted context, said received process is received from a third process operating in said non-secure execution environment; and provides said decrypted context to a fourth process operating in said secure execution environment.

3. The apparatus of claim 2, wherein said received context comprises said encrypted context.

4. The apparatus of claim 2, wherein said third process comprises said second process.

5. The apparatus of claim 2, wherein said third process is different than said second process.

6. The apparatus of claim 2, wherein said fourth process comprises said first process.

7. The apparatus of claim 2, wherein said fourth process is different than said first process.

8. The apparatus of claim 1, wherein said context processing module generates authentication information corresponding to said processed context, and authenticates a context received from said non-secure execution environment based on said authentication information.

9. The apparatus of claim 1, wherein said context processing module generates integrity information corresponding to said processed context, and verifies the integrity of a context received from said non-secure execution environment based on said integrity information.

10. The apparatus of claim 1, wherein said context processing module generates session information identifying a session during which said encrypted context is generated, and verifies the session of a context received from said non-secure execution environment based on said session information.

11. The apparatus of claim 1, wherein said context processing module stores said encrypted context in a memory address associated with said non-secure execution environment.

12. The apparatus of claim 1, wherein said first process comprises at least part of a cryptographic process.

13. The apparatus of claim 1, wherein said context processing module operates in said secure execution environment.

14. A method of maintaining one or more contexts of a secure execution, said method comprising:
receiving a processed context from a first process operating in said secure execution environment;
encrypting said processed context using a secret key maintained in said secure execution environment to generate an encrypted context; and
providing said encrypted context to a second process operating in a non-secure execution environment.

15. The method of claim 14 comprising:
receiving from a third process operating in said non-secure execution environment a received context;
decrypting said received context using said secret key to generate a decrypted context; and
providing said decrypted context to a fourth process operating in said secure execution environment.

16. The method of claim 15, wherein receiving said received context comprises receiving said encrypted context.

17. The method of claim 15, wherein receiving said received context comprises receiving said received context from a process comprising said second process.

18. The method of claim 15, wherein receiving said received context comprises receiving said received context from a process different than said second process.

19. The method of claim 15, wherein providing said decrypted context comprises providing said decrypted context to a process comprising said first process.

20. The method of claim 15, wherein providing said decrypted context comprises providing said decrypted context to a process different than said first process.

21. The method of claim 14 comprising:
generating authentication information corresponding to said processed context; and
authenticating a context received from said non-secure execution environment based on said authentication information.

22. The method of claim 14 comprising:
generating integrity information corresponding to said processed context; and
ensuring the integrity of a context received from said non-secure execution environment based on said integrity information.

23. The method of claim 14 comprising:
generating session information identifying a session during which said context is encrypted; and
verifying a session of a context received from said non-secure execution environment based on said session information.

24. The method of claim 14 comprising storing said encrypted context in a memory address associated with said non-secure execution environment.

25. The method of claim 14, wherein receiving said processed context comprises receiving said processed context from a cryptographic process.

26. The method of claim 14, comprising performing said receiving, encrypting and providing in said secure execution environment.

27. A computing system comprising:
a secure context processing module to:
receive a processed context from a first process operating in a secure execution environment;
encrypt said processed context using a secret key maintained in said secure execution environment to generate an encrypted context; and
provide said encrypted context to a second process operating in a non-secure execution environment; and
a memory to store said encrypted context.

28. The system of claim 27, wherein said context processing module decrypts a received context using said secret key to generate a decrypted context, said received process is received from a third process operating in said non-secure execution environment; and provides said decrypted context to a fourth process operating in said secure execution environment.

29. The system of claim 27, wherein said context processing module generates session information identifying a session during which said encrypted context is generated, and verifies the session of a context received from said non-secure execution environment based on said session information ( Session information is embedded in the encrypted context).
